(19) United States
(12) Patent Application Publication
(10) Pub. No.: US 2010/0128467 A1
(43) Pub. Date: May 27, 2010

(54) Backlit Devices with Multiwall Sheets and Methods of Making the Same

(75) Inventors: David L. Hartter, Pittsfield, MA (US); Todd A. Hoff, Pittsfield, MA (US); Victor Chiang, Panchiao (TW); Joseph Riello, Pittsfield, MA (US); John F. Graf, Ballston Lake, NY (US)

Correspondence Address: CANTOR COLBURN, LLP, 20 Church Street, 22nd Floor, Hartford, CT, 06103, US

(73) Assignee: SABIC INNOVATIVE PLASTICS IP B.V., Bergen op Zoom (NL)

(21) Appl. No.: 12/517,610

(22) PCT Filed: Sep. 12, 2007
(86) PCT No.: PCT/US2007/019813

§ 371 Date: Dec. 14, 2009

Related U.S. Application Data
(63) Continuation of application No. 11/566,404, filed on Dec. 4, 2006, now abandoned.

(51) Int. Cl. G02F 1/13357; H01J 9/24

(52) U.S. Cl. 362/97.2; 362/97.1; 445/24

(57) ABSTRACT

Disclosed herein are backlit devices comprising multiwall sheets (120,220). In one embodiment, a backlit device comprises: a multiwall sheet (120,220) and a light source (106). The multiwall sheet (120,220), that has a viewing side (114), comprises polymer walls and a rib that intersects at least two of the walls. The rib comprises a non-linear geometry. The light source (106) is located on a side of the multiwall sheet (120,220) opposite the viewing side (114), wherein the light source (106) is configured to direct light (104) at the multiwall sheet (120,220).

### CROSS REFERENCE TO RELATED APPLICATIONS

This application is a 371 of International Application No. PCT/US2007/019813, filed Sep. 12, 2007 which claims priority to U.S. application Ser. No. 11/566,404, filed Dec. 4, 2006, both of which are hereby incorporated by reference in its entirety.

### BACKGROUND

In many backlit display devices, for example in liquid crystal display televisions (LCD TV), there is a demand for larger and larger displays. As the size of a display increases, the number of light sources (e.g., a cold cathode fluorescent lamp (CCFL)) used to backlit the display can also increase. Accordingly, the backlit display system can desirably comprise a light diffusing sheet (also referred to as a light diffusing plate, a film, and the like). Examples of the utility of the light diffusing sheet includes, but is not limited to, hiding the light and dark pattern that can be created by an array of CCFLs, providing uniformity in illumination, and the like.

Backlit flat panel displays (LCD) can utilize a cold cathode florescent lamp as a light source. This is for direct lit applications where lamps are behind the diffuser sheet. This is commonly accomplished with a film with light diffusion type functionality to provide light spreading and decoration type functions. As the applications and products change (e.g., flat panel televisions) there is a desire to reduce weight while retaining or improving the film properties such as uniformity and luminance.

Accordingly, a continual need exists in the art for improved light diffusing devices, especially those light diffusing sheets employed in LCD TVs and other types of backlit devices.

### SUMMARY

Disclosed herein are light diffusing sheets, methods of making the same, and articles using the same.

Disclosed herein are backlit devices comprising multiwall sheets. In one embodiment, a backlit device comprises: a multiwall sheet and a light source. The multiwall sheet, that has a viewing side, comprises polymer walls and a rib that intersects at least two of the walls. The rib comprises a non-linear geometry. The light source is located on a side of the multiwall sheet opposite the viewing side, wherein the light source is configured to direct light at the multiwall sheet.

In another embodiment, a backlit device comprises: a multiwall sheet and a light source. The multiwall sheet, which has a viewing side. The multiwall sheet comprises walls and a rib that intersects at least two of the walls. The rib has a rib transmission that is greater than a wall transmission as determined in accordance with ASTM D1003-00. The light source is located on a side of the multiwall sheet opposite the viewing side, wherein the light source is configured to direct light at the multiwall sheet.

In yet another embodiment, a backlit device comprises: a multiwall sheet having a viewing side and a light source located on a side of the multiwall sheet opposite the viewing side. The multiwall sheet comprises polymer walls and a rib that intersects at least two of the walls. The rib comprises a textured surface. The light source is configured to direct light at the multiwall sheet.

In yet another embodiment, a backlit device comprises: a multiwall sheet having a viewing side, a light source located on a side of the multiwall sheet opposite the viewing side, and a collimating sheet located on the viewing side of the multiwall sheet. The multiwall sheet comprises polymer walls and a rib that intersects at least two of the walls. The multiwall sheet has a weight of less than or equal to about 1.9 kg/m². The device has a hiding power of 0 to about 2.0.

In one embodiment, a method for making a backlit device comprises: locating a multiwall sheet between a light source and a collimating sheet, wherein the multiwall sheet comprises polymer walls and a rib that intersects at least two of the walls. The method can further comprise coextruding the multiwall sheet and a diffuser sheet, and/or comprise disposing a liquid crystal display on a side of the collimating sheet opposite the multiwall sheet.

The above-described and other features will be appreciated and understood from the following detailed description, drawings, and appended claims.

### BRIEF DESCRIPTION OF THE DRAWINGS

Refer now to the figures, which are exemplary embodiments, and wherein the like elements are numbered alike.

FIG. 1 is a perspective view of an exemplary embodiment of a backlit display device including a collimating sheet and a multiwall sheet.

FIG. 2 is a perspective view of an exemplary embodiment of a collimating sheet with prismatic surfaces.

FIG. 3 is a cross-sectional, exploded view of another embodiment of a backlit display device comprising a diffusing film between an array of cold cathode fluorescent lamps and a multiwall sheet.

FIG. 4 is a top view of one embodiment of a linear array of fluorescent lamps.

FIGS. 5-8 are various cross-sectional embodiments of multiwall sheets.

FIGS. 9 and 10 are illustrations of viewing of multiwall sheets.

FIGS. 11 and 12 are graphical illustrations of luminance versus hiding power for various types of sheets.

FIG. 13 is a graphical representation of an exemplary advantage in luminance attained by employing the multiwall sheet versus a solid sheet.

### DETAILED DESCRIPTION

Disclosed herein are optical films, more particularly multiwall diffusing sheets comprising a polymeric material. These sheets have equal or greater hiding power, and/or reduced weight (e.g., a weight of less than or equal to 1.9 kilograms per square meter (kg/m²), or, more specifically, less than or equal to 1.7 kg/m², e.g., about 0.7 kg/m² to about 1.6 kg/m²), and equal or greater stiffness than many other light diffusing sheets, e.g., typical substrates such as polycarbonate, acrylic and cyclic olefin co-polymers, and so forth, thereby providing a significant commercial advantage. Additionally, comparable hiding power to other multiwall sheets has also been attained. The multiwall sheets can comprise rib(s) comprising a different composition than the wall(s) (e.g., the outer walls comprise the same material and the rib(s) comprise a different material; the rib(s) and an outer wall comprise the same material, and the other outer wall comprises a different material; in each of these, any inner wall(s) can comprise the same or a different material than the outer wall(s) and than the rib(s)), rib(s) having a different thickness than the wall(s) (e.g., about 25% to about 80% of the wall thickness, or, more specifically, about 25% to about 60%), and/or the rib(s) and/or outer wall(s) can be textured).

These multiwall sheets can be used in a backlit display (e.g., computer screen, TV, signage, general lighting and so forth). The device can comprise the multiwall sheet with a light source disposed on a non-viewing side of the multiwall sheet and configured to direct light through the multiwall sheet. Optionally, diffuser film(s) and/or collimating film(s) can also be used. Generally the collimating film(s) can be located on the viewing side of the multiwall sheet. In order to further “hide” rib(s) of the multiwall sheet, diffuser film(s) or coating can be located on either side of the multiwall sheet.

In one embodiment, a backlit device comprises: a multiwall sheet and a light source. The multiwall sheet, that has a viewing side, comprises polymer walls and a rib that intersects at least two of the walls. The rib comprises a non-linear geometry. The light source is located on a side of the multiwall sheet opposite the viewing side, wherein the light source is configured to direct light at the multiwall sheet. Optionally, the outer wall of the multiwall sheet can comprise indentations, and wherein the light source is disposed adjacent to the indentations. The device can have a hiding power of 0 to about 2. The rib can comprise a different composition than at least one of the walls, can have a different thickness than at least one of the walls, and/or can be textured. The rib thickness can be about 25% to about 80% of a wall thickness. Also, the multiwall sheet can have a weight of less than or equal to 2 kg/m². The device can be free of a diffusing sheet between the light source and the multiwall sheet (i.e., no diffusing sheet between the multiwall sheet and the light source), in some embodiments, the multiwall sheet can be directly adjacent to the light source (i.e., no intervening sheets). The device can further comprise a collimating sheet located on the viewing side of the multiwall sheet, e.g., between the viewing side of the multiwall sheet and a liquid crystal display. In order to attain a balance between stiffness and uniformity, the non-linear ribs can have a ratio of period to amplitude of (period/amplitude) of about 0.6 to about 5.4, or, more specifically, about 1.1 to about 3.1.

In another embodiment, a backlit device comprises: a multiwall sheet and a light source. The multiwall sheet, which has a viewing side, wherein the multiwall sheet comprises walls, wherein an outer wall on the viewing side has a wall transmission and a rib that intersects at least two of the walls. The rib has a transmission that is greater than the wall transmission as determined in accordance with ASTM D1003-00. The light source is located on a side of the multiwall sheet opposite the viewing side, wherein the light source is configured to direct light at the multiwall sheet.

In yet another embodiment, a backlit device comprises: a multiwall sheet having a viewing side and a light source located on a side of the multiwall sheet opposite the viewing side. The multiwall sheet comprises polymer walls and a rib that intersects at least two of the walls. The rib comprises a textured surface. The light source is configured to direct light at the multiwall sheet.

In still another embodiment, a backlit device comprises: a multiwall sheet having a viewing side, a light source located on a side of the multiwall sheet opposite the viewing side, and liquid crystal display located on the viewing side of the multiwall sheet, and a collimating sheet located between the liquid crystal display and the collimating sheet. The multiwall sheet comprises polymer walls and a rib that intersects at least two of the walls, wherein the rib comprises a sinusoidal geometry. Optionally, a diffuser sheet can be located between the multiwall sheet and the collimating sheet.

In yet another embodiment, a backlit device comprises: a multiwall sheet having a viewing side, a light source located on a side of the multiwall sheet opposite the viewing side, and a collimating sheet located on the viewing side of the multiwall sheet. The multiwall sheet comprises polymer walls and a rib that intersects at least two of the walls. The multiwall sheet has a weight of less than or equal to 1.9 kg/m². The device has a hiding power of 0 to about 2.0.

In one embodiment, a method for making a backlit device comprises: locating a multiwall sheet between a light source and a collimating sheet, wherein the multiwall sheet comprises polymer walls 132, 134 and a rib 130 that intersects at least two of the walls. The method can further comprise coextruding the multiwall sheet and a diffuser sheet, and/or comprise disposing a liquid crystal display on a side of the collimating sheet opposite the multiwall sheet.

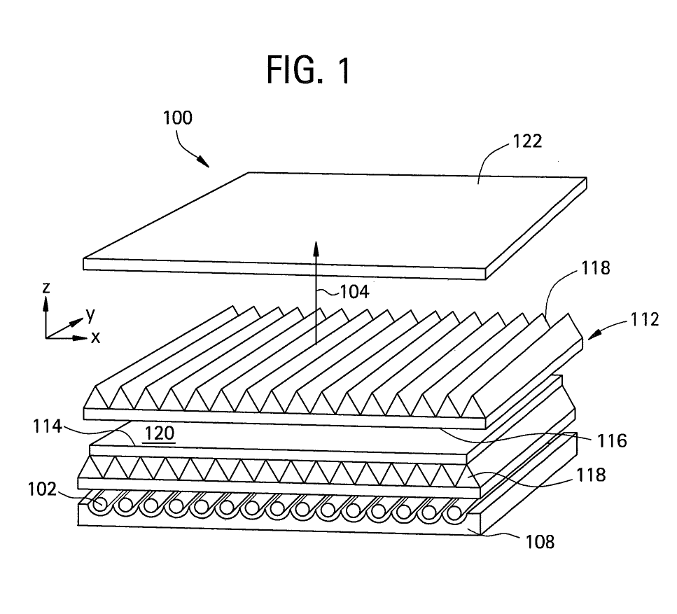

Referring now to FIG. 1, a perspective view of a backlit display device generally designated 100 is illustrated. The backlit display device 100 comprises an optical source 102 for generating light 104. A reflective film 108 in physical and/or optical communication the light source 102 reflects the light toward the liquid crystal display (LCD) 122. A multiwall sheet 120 that is in optical communication with the light source 102, e.g., generally disposed at a distance of up to about 15 millimeters (mm) from the light source. From a viewing side of multiwall sheet 120, the light passes from the multiwall sheet 120, optionally through diffuser sheet(s) (not shown), and into collimating sheet 112.

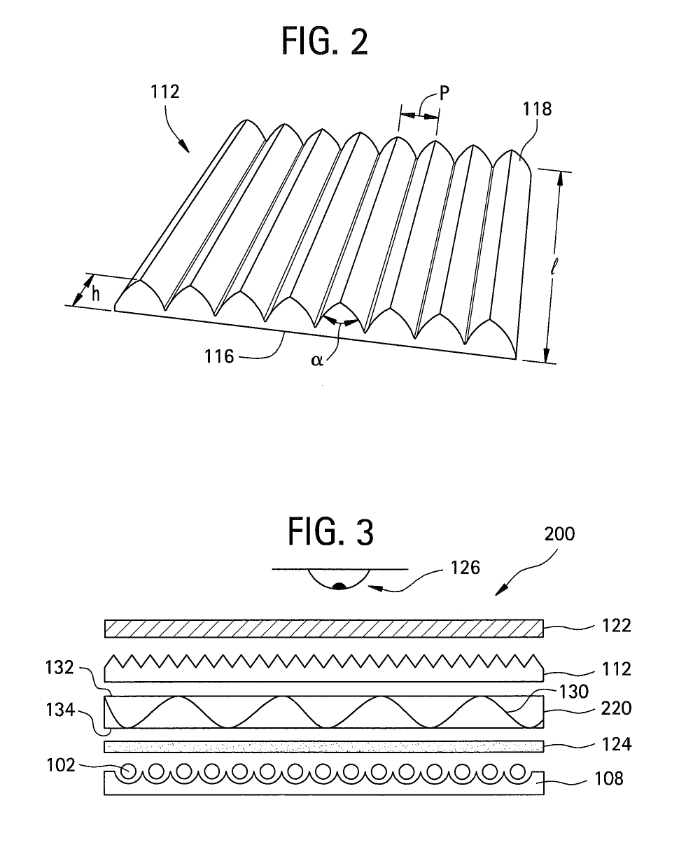

The collimating sheet 112 comprises a planar surface 116 in physical and/or optical communication with the viewing side 114 of multiwall sheet 120, and a prismatic surface 118 in physical and/or optical communication with light-diffusing film 120. Still further, it will be appreciated that the prismatic surfaces 118 can comprise a peak angle, α, a height, h, a pitch, p, and a length, l (see exemplary FIG. 2) such that the structure of the collimating sheet 112 can be deterministic, periodic, random, and so forth. For example, films with prismatic surfaces with randomized or pseudo-randomized parameters are described for example in U.S. Patent Application No. 2003/0214728 to Olcazk. Moreover, it is noted that for each prism the sidewalls (facets) can be straight-side, concave, convex, and so forth. The peak of the prism can be pointed, multifaceted, rounded, blunted, and so forth. More particularly, in some embodiments the prisms comprise straight-sided facets having a pointed peak (e.g., a peak comprising a radius of curvature of about 0.1% to about 30% of the pitch (p)), particularly about 1% to about 5%).

The multiwall sheet 120, which is receptive of the light 104, diffuses (e.g., scatters) the light. The collimating sheet 112 receives the light 104 and acts to direct the light 104 in a direction that is substantially normal to the collimating sheet 112 as indicated schematically by an arrow representing the light 104 being directed in a z-direction shown in FIG. 1. The light 104 proceeds from the collimating sheet 112 to a liquid crystal display (LCD) 122. Optionally, reflective polarizing sheet(s) can also be employed between the multiwall sheet and the LCD. The reflective polarizing sheet(s) (e.g., a recycling polarizer sheet) reflects some polarized light (e.g., the polarized light that is not in the correct direction to be received by the LCD), while transmitting other polarized light.

FIG. 3 is a cross-sectional, exploded view of another exemplary backlit display device generally designated 200 and also comprising a direct light source 102. The backlit display device 200 includes multiple components arranged (e.g., stacked) in various combinations depending on the desired application. Generally, the backlit display device 200 can comprise two outer components with varying components disposed between the two outer components. For example, the backlit display device 200 can comprise LCD(s) 122 defining an outer side closest to a viewer 126 of the backlit display device 200 and a reflective film 108 defining the second outer side. Optional light diffusing sheet(s) 124 can be disposed between the LCD 122 and the reflective article 108 such that the light diffusing sheet 124 can be in physical communication and/or optical communication with the light source 102, and can be disposed on either or both sides of the multiwall sheet(s) 120. The backlit display device 200 can further comprise multiwall sheet(s) 220 and collimating sheet(s) 112 between the light source 102 and the LCD 122. Optional collimating sheet(s) 112 can be located at the viewing side of the multiwall sheet 220.

Further, it is noted that in various embodiments a backlit display device can comprise a plurality of collimating sheet(s) and a plurality of diffusing films in optical communication with each other. The multiwall sheet(s), collimating sheet(s), and diffusing film(s) can be arranged in any configuration to obtain the desired results in the display device. Additionally, the collimating sheet(s) can be arranged such that the prismatic surfaces are positioned at an angle with respect to one another, e.g., 90 degrees. Generally, the arrangement and type of collimating sheets, multiwall sheet(s) and diffusing film(s) depends on the backlit display device in which they are employed.

While the light diffusing films are particularly suited for use in liquid crystal display televisions (LCD TVs), it is to be understood that any reference to LCD TVs throughout this disclosure is made merely for ease in discussion and it is to be understood that other devices and applications are envisioned to be within the scope of this disclosure. For example, the light diffusing film can be employed in any display device (e.g., a backlit display device), such as LCD TVs, computer (e.g., laptop computers), instrument displays, backlit signage, and so forth.

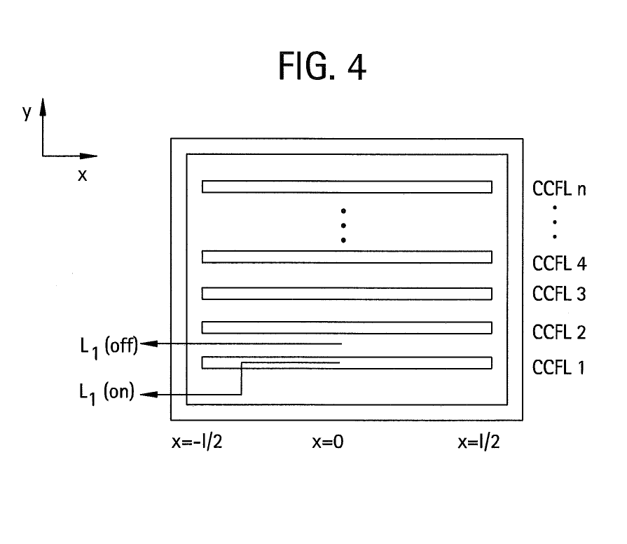

The term “hiding power” as used herein refers to the ability of light diffusing films to mask the light and dark pattern produced by, for example, a linear array of fluorescent lamps (e.g., cold cathode fluorescent lamps). Quantitatively, hiding power can be mathematically described by FIG. 4 and the following equation:

$$Hiding power ( \% ) = \vert 1 - \frac{{\sum }_{i = 1}^{n - 1} {L}_{i} ( on )}{{\sum }_{j = 1}^{n - 1} {L}_{j} ( off )} \vert \times 100$$

where:

Lᵢ(on)=Luminance above with CCFL

Lⱼ(off)=Luminance at the midpoint between lamp j and lamp j+1

n: number of CCFL lamps

The point between adjacent CCFLs is relatively darker in comparison to the point above a CCFL. By way of example, the terms L (on) and L (off) and CCFL are shown in FIG. 4 in relation to a top view of an array of CCFLs. Luminance values that are used to calculate hiding power (Lᵢ(on) and Lⱼ(off)) are measured along the points on vertical y axis, where x coordinate is equal to 0, where “1” is the length of CCFL lamp as shown in FIG. 4. The average luminance is defined in relation to a 13 points test determined per Video Electronic Standard Association (VESA) flat panel display measurements (FPDM) version 2.

The hiding power of the multiwall sheet is dependent upon the particular application as well as components employed with the multiwall sheet. The multiwall sheet, for example, can have a hiding power of up to and exceeding 10, or, more specifically, a hiding power of less than or equal to about 5, or, even more specifically, less than or equal to about 2, and even more specifically, less than or equal to about 1. Meanwhile, the backlit device, or at least the sheet stack (e.g., multiwall sheet(s), diffuser film(s), and collimating film(s)), in order to avoid shadows, can have a hiding power of 0 to about 2, or, more specifically, of 0 to about 1, and, even more specifically, 0 to about 0.5. Unless specifically specified to the contrary, hiding power is calculated by the above described mathematical formula for hiding power and measured using a Microvision SS320 instrument (commercially available from Microvision Inc., U.S.). As used herein, unless expressly stated otherwise, luminance is determined as compared to PC 1311-60 (commercially available from Teijin Chemical Ltd. of Japan) which has 60% transmission.

The number of light source(s) 102 can vary depending on the desired application and the size of the backlit display device 100,200. The light source 102 can include any light source suitable to backlit the LCD 122. Suitable light sources include, but are not limited to, fluorescent lamps (e.g., cold cathode fluorescent lamps (CCFLs), hot cathode fluorescent lamps (HCFLs)), light-emitting diode(s), and so forth, as well as combinations comprising at least one of the foregoing.

The reflective film 108, which comprises a light reflective material, can take many forms (e.g., a planar shape, such as a plate, a sheet, and the like), angled, and so forth. Possible reflective materials include metals (e.g., aluminum, silver, and so forth), metal oxides (e.g., titanium oxide, and so forth), thermoplastic materials (e.g., Spectralon® commercially available from Labsphere, Inc.), and so forth, as well as combinations comprising at least one of the foregoing, such as titanium oxide pigmented Lexan® (commercially available from General Electric Co.), and the like.

The collimating sheet 112 can use light-directing structures (e.g., prismatic structures) to direct light along the viewing axis (i.e., normal to the display), which enhances the brightness of the light viewed by the user (e.g., viewer 126) of the display and which allows the system to use less power to create a desired level of on-axis illumination. For example, the collimating sheet can include macroscale, microscale, and/or nanoscale surface features (e.g., retroreflective elements, and so forth). Macroscale surface features have a size of approximately 1 millimeter (mm) to about 1 meter (m) or the entire size of the part being formed; i.e. of a size scale easily discerned by the human eye. Microscale surface features have a size of less than or equal to about 1 mm, or, more specifically, greater than 500 nanometers (nm) to about 1 mm. Nanoscale surface features have a size of less than or equal to 500 nm, or, more specifically, less than or equal to about 100 nm. Some possible surface features (e.g., retroreflective elements) include various geometries (cube-corners (e.g., triangular pyramid), trihedral, hemispheres, prisms, ellipses, tetragonal, grooves, channels, and others, as well as combinations comprising at least one of the foregoing)). Some possible structures and materials are discussed in U.S. Patent Publication No. 2003/0108710 to Coyle et al., and in U.S. patent application Ser. No. 11/326,158 to Capaldo et al.

More specifically, a base film material of the collimating sheet can comprise metal, paper, acrylics, polycarbonates, phenolics, cellulose acetate butyrate, cellulose acetate propionate, poly(ether sulfone), poly(methyl methacrylate), polyurethane, polyester, poly(vinylchloride), polyethylene terephthalate, and the like, as well as blends copolymers, reaction productions, and combinations comprising at least one of the foregoing.

In one embodiment, the base film of the collimating sheet is formed from a thermoplastic polycarbonate resin, such as Lexan® resin, commercially available from General Electric Company, Pittsfield, Mass. Thermoplastic polycarbonate resin that can be employed in producing the base film, include without limitation, aromatic polycarbonates, copolymers of an aromatic polycarbonate such as polyester carbonate copolymer, blends thereof, and blends thereof with other polymers depending on the end use application. In another embodiment, the thermoplastic polycarbonate resin is an aromatic homo-polycarbonate resin such as the polycarbonate resins described in U.S. Pat. No. 4,351,920 to Ariga et al. These polycarbonate resins can be obtained by the reaction of an aromatic dihydroxy compound with a carbonyl chloride. Other polycarbonate resins can be obtained by the reaction of an aromatic dihydroxy compound with a carbonate precursor such as a diaryl carbonate. An exemplary aromatic dihydroxy compound is 2,2-bis(4-hydroxy phenyl) propane (i.e., Bisphenol-A). A polyester carbonate copolymer is obtained by the reaction of a dihydroxy phenol, a carbonate precursor and dicarboxylic acid such as terephthalic acid or isophthalic acid or a mixture of terephthalic and isophthalic acid. Optionally, an amount of a glycol can also be used as a reactant. In other embodiments, an anti-static material can optionally be added to the base film of the collimating sheet in an amount sufficient to impart anti-static properties to the film.

The diffusing film can comprise various polymeric materials and optionally light diffusing particles. The polymeric material can be a material that, when made into a ⅛^{th} inch (3.18 mm) thick bar, the bar has a light transmission of greater than or equal to about 80%. Unless specifically set forth herein otherwise, all transmission is measured using a ⅛^{th} inch thick bar and in accordance with ASTM D1003-00, procedure B measured with instrument Macbeth 7000A, D65 illuminant, 10° observer, CIE (Commission Internationale de L'Eclairage) (1931), and SCI (specular component included), and UVEXC (i.e., the UV component is excluded); while haze uses the same variables with procedure A. Exemplary polymeric materials include polycarbonate, poly(methyl)acrylate, poly(ethylene terephthalate) (PET), as well as combinations comprising at least one of the foregoing, such as methyl methacrylate-styrene (MS) copolymer.

Possible light diffusing particles include materials that have the desired optical properties, including the desired refractive index. Desirably, these particles have sufficient compatibility with the matrix material and can be produced with the desired surface characteristics. Some possible particles include organic and/or inorganic particles (e.g., polymers, silsesquioxanes (such as polyhydride silsesquioxanes), and so forth). Some possible types of light-diffusing particles are organic polymers such as, for example, fluorinated polymers (e.g., poly(tetrafluoroethylene)), and homopolymers, and copolymers formed from styrene and derivatives thereof, as well as acrylic acid and derivatives thereof, for example C₁₋₈ alkyl acrylate esters, C₁₋₈ alkyl methacrylate esters, and so forth. Still another possible type of light-diffusing particle is inorganic, for example metal sulfates (such as barium sulfate, calcium sulfate, and so forth), metal oxides and hydroxides (such aluminum oxide, zinc oxide, silicon dioxide, and so forth), metal carbonates (such as calcium carbonate, magnesium carbonate, and so forth), metal silicates such as sodium silicate, aluminum silicate, and mica, clay, and so forth, as well as combinations comprising at least one of the foregoing inorganic materials. Combinations comprising at least one of any of the above particles can also be employed. Exemplary particles are disclosed in U.S. patent application Ser. No. 11/382,097 to Cojocariu et al.

While the thickness of the light diffusing sheet can vary depending on the desired application. For LCD TV applications, it has been discovered that the desired hiding power and luminance can be obtained when the light diffusing sheet has a thickness of about 0.5 millimeters (mm) about to about 5.0 mm, or, more specifically, about 1.0 to about 4.0 mm, or, even more specifically about 1.4 mm to about 3 mm, and even more specifically, a thickness of about 1.8 mm to about 2.2 mm. For other applications, the thickness can be up to and exceeding about 15 mm, or, more specifically, less than or equal to about 10 mm.

In various embodiments, the light diffusing film can have a polished surface, a textured surface, or a combination comprising at least one of the foregoing. More particularly, the light diffusing film can comprise any surface texture that can provide the desired ease in handling and provides the desired cosmetic effect. For example, the light diffusing film can have a surface roughness (Ra) of about 0.01 micrometer to about 2 micrometers, or, more particularly, a surface roughness of about 0.25 micrometers to about 0.65 micrometers, wherein surface roughness values are measured in accordance with Japanese Industrial Standards (JIS B0601) as measured using a Kosaka ET4000 Surface profilometer. The Ra is a measure of the average roughness of the film. It can be determined by integrating the absolute value of the difference between the surface height and the average height and dividing by the measurement length for a one dimensional surface profile, or the measurement area for a two dimensional surface profile.

The multiwall sheet(s) comprise the walls and the rib(s), wherein the wall(s) and/or rib(s) can comprise the same or a different polymeric material. Possible polymeric materials include polyalkylenes, polycarbonates, acrylics, polyacetals, styrenes, poly(meth)acrylates, polyetherimide, polyurethanes, polyphenylene sulfides, polyvinyl chlorides, polysulfones, polyetherketones, polyether etherketones, polyether ketone ketones, and combinations comprising at least one of the foregoing. For example, the polymeric material can be acrylonitrile-butadiene-styrene/nylon, polycarbonate/acrylonitrile-butadiene-styrene, acrylonitrile butadiene styrene/polyvinyl chloride, cyclic olefin, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleic anhydride/acrylonitrile-butadiene-styrene, polyether, as well as combinations comprising at least one of the foregoing polymers. If the rib comprises a different material than the viewing side wall(s), the rib(s) can comprise a material with a greater light transmission than the viewing side wall (e.g., greater than or equal to 5% higher than the wall light transmission, or, more specifically, greater than or equal to 10% higher, or, even more specifically, greater than or equal to 15% higher).

The number of layers (e.g., walls) of the multiwall sheet is dependent upon customer requirements such as structural integrity, overall thickness, light transmission properties, and others. Although the thickness of the sheets can be up to and even exceed about 55 millimeters (mm), for backlit display applications, the multiwall sheet overall thickness is generally less than or equal to about 10 mm, or, more specifically, less than or equal to about 5 mm, e.g., about 2 mm to about 5 mm, or, more specifically, about 1 mm to about 2 mm. Each wall can have a thickness of less than or equal to about 1 mm, or, more specifically, about 50 micrometers (μm) to about 500 μm, or, even more specifically, about 100 μm to about 400 μm.

The rib(s) can have the same or a different thickness than the walls. In the backlit display application, it is generally preferable to have thinner ribs than walls to diminish the possible visibility of the rib(s). The rib(s) can have a thickness of about 30% to about 90% of the wall thickness, or, more specifically, about 45% to about 80% of the wall thickness, or, even more specifically, about 55% to about 80% of the wall thickness, and, yet more specifically, about 65% to about 75% of the wall thickness.

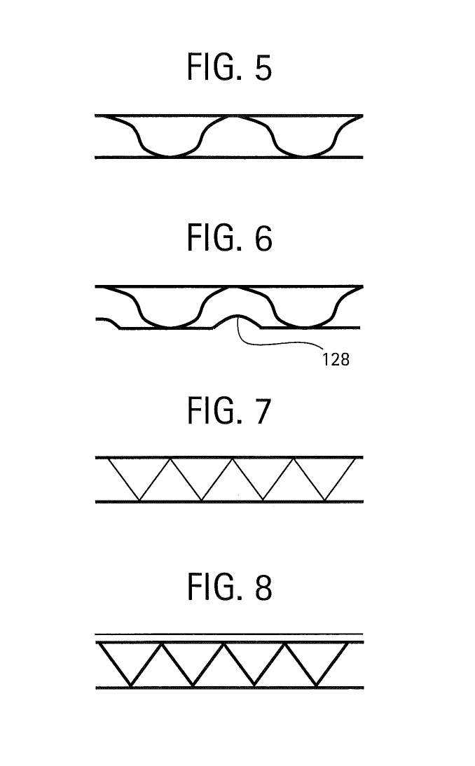

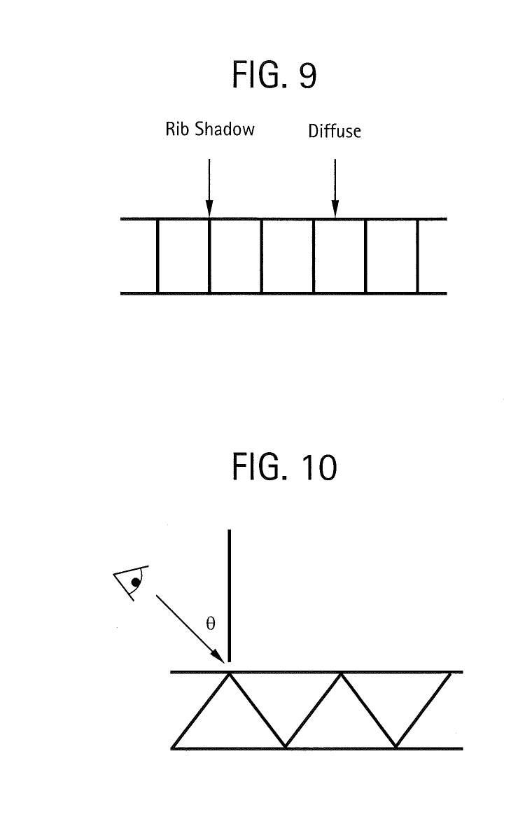

The number of rib(s) and rib geometry is based upon the ability to inhibit the ribs from producing shadows on the backlit display (e.g., to prevent the ribs from being visible), while attaining the desired structural integrity. The rib(s) can have various geometries such as a non-linear (e.g., a sinusoidal geometry such as in FIGS. 5 and 6; and other curved geometries), triangular (zig zag) geometry (e.g., see FIGS. 7, 8, and 10), perpendicular (e.g., see FIG. 9), as well as any other geometries, and combinations comprising at least one of these geometries.

Reducing of the visibility of the rib(s) can be accomplished in several fashions. FIGS. 5 and 6 illustrate sinusoidal ribs which attain a high degree of hiding power. As can be seen in FIG. 6, the walls can also have a non-planar geometry where desired, e.g., to accept the light source. In FIG. 6, the wall opposite the viewing side, has indentations 128 configured to receive (e.g., be disposed in physical communication with) a light source. FIG. 7 illustrates rib(s) comprising a different composition than the walls such that the ribs have a higher transparency and therefore reduced visibility. FIG. 8 illustrates a diffusing element disposed on the viewing side of the multiwall sheet, wherein the diffusing element can be a diffuser film and/or a coating on the multiwall sheet. FIGS. 9 and 10 illustrate the issue of “rib shadows”. As one views a display comprising a multiwall sheet, rib(s) can be visible in the areas of the ribs creating a “shadow” on the display. Depending upon the rib geometry, amplitude, and period, the angle at which the shadowing is seen can change (e.g., see FIG. 9 versus FIG. 10). With the sinusoidal ribs, the shadowing has been reduced or eliminated.

The backlit device can be form in many fashions, for example, the various sheets can be formed separately and assembled in a desired configuration, and/or some of the sheets can be coextruded. For example, the multiwall sheet can be coextruded with diffuser sheet(s) on one or both sides of the multiwall sheet. Other possible techniques for forming the multiwall sheet comprise profile extrusion, lamination, as well as combinations comprising at least one of any of the foregoing techniques.

### EXAMPLES

The materials set forth in Table 1 were used in the Examples.

TABLE 1

| | | Commercially |
|---|---|---|
| Commercial Name | Chemical Name | Available From: |
| Lexan ® | polycarbonate | General Electric |
| | | Plastics, Pittsfield, |
| | | MA |
| PC1311-50; | polycarbonate light diffusing | Teijin Chemical |
| PC 1311-60 | sheets | Ltd., Japan |
| Tospearl ® 120 | poly(methyl silsesquioxane) | General Electric |
| | | (GE) Silicones |
| BE2039 | Polycarbonate film: 203 μm | General Electric |
| | thickness, 96-97% haze | (GE) |
| DL4251 | Polycarbonate film, | General Electric |
| | 127 micron thickness, | (GE) |
| | 97-98% haze | |
| D121 | PET film, 130 micron | Tsujiden, Japan |
| | thickness, 78.5% haze | |

### Example 1

### Luminance Vs. Hiding Power for Multiwall Sheet Versus PC 1311-60

Sample 1 was a multiwall sheet with a one light diffusing film placed on the multiwall sheet; Sample 2 was PC 1311-60 with a one light diffusing film placed on the multiwall sheet; Sample 3 was the same multiwall sheet of Sample 1, with a two light diffusing films placed on the multiwall sheet; and Sample 4 the same film as Sample 2 with a two light diffusing films placed on the multiwall sheet. In all cases, the light diffusing film(s) were and had a 203 micrometer (μm) thickness with a textured surface (e.g., GE Plastics' diffusing film, tradename Illuminex® BE2039). The multiwall sheet was a non linear rib structure between two outer walls, wherein the viewing side wall comprised BE2039, the ribs and the other outer wall comprised polycarbonate with Tospearl™ light diffusing particles, and had a thickness of 127 μm (commercially available from GE Plastics, under the tradename Illuminex® DL4251). This multiwall sheet was formed by forming the middle DL4251 film, placing on a DL4251, and then placing a BE1279 on the formed film.

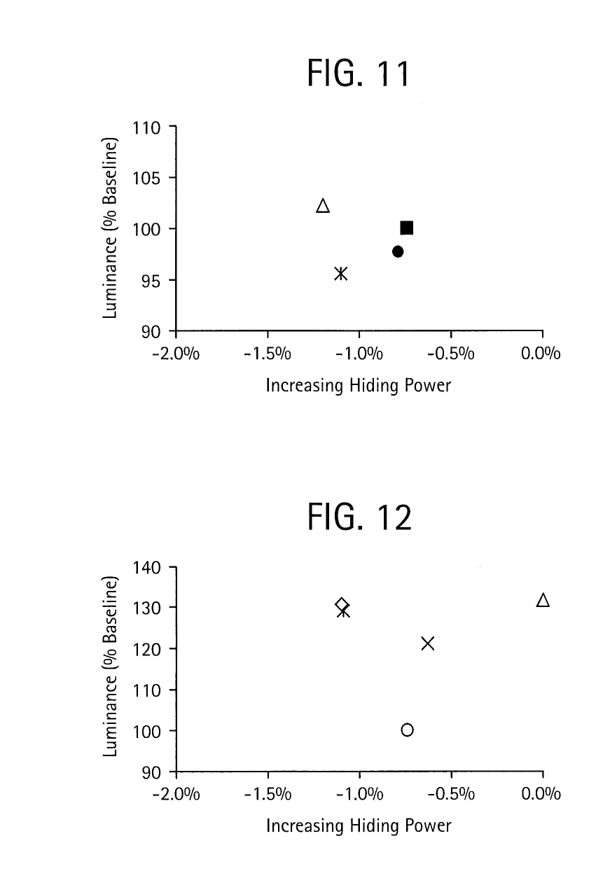

Referring to FIG. 11, luminance versus hiding power graphically depicted for Samples 1-4. As can be seen from the graph, in order to attain a hiding power of −1.0 to 0, two bottom diffusers were used (Samples 3 and 4; the circle and square, respectively). However, for the multiwall sheet, the luminance, with two bottom diffusing films, was less than 100%. It is also noted, that with one bottom diffuser, the luminance was greater than 100% (Sample 1 (illustrated as the triangle)), but for the PC 1311-60, the use of one bottom diffuser decreased the luminance from 100% (Sample 2; the square) to near 95% (Sample 4; the star).

### Example 2

### Luminance Vs. Hiding Power for Multiwall Sheet Versus PC 1311-60 Using Collimating Sheet

For Samples 5-8, a collimating sheet was disposed on a viewing side of the sample (i.e., the side opposite the light source, wherein any diffuser was placed on the sheet). The collimating sheet was GE Plastics Illuminex® PS1670, 167 μm thick (commercially available from GE Plastics, under the tradename Illuminex®). The multiwall sheet was the same as in Example 1. Sample 5 (the triangle) was the multiwall sheet with the collimating sheet; Sample 6 (the star) was PC 1311-60 with the collimating sheet; Sample 7 (the “X”) was the multiwall configuration of Sample 1 with the collimating sheet; and Sample 8 (the diamond) was the film configuration of Sample 2 with the collimating sheet.

Referring to FIG. 12, luminance versus hiding power graphically depicted for Samples 4-8 (symbols: circle, triangle, star, X, diamond, respectively). As can be seen from the graph, in order to attain a hiding power of −1.0 to 0, PC1311-60 required two bottom diffusers (Sample 4), and was not able to attain this hiding power with the collimating film (Sample 6), even with the collimating film and one diffuser (Sample 8). However, the multiwall sheet with one bottom diffuser attained a hiding power of about −0.6, and a luminance of about 120% (Sample 7), while the multiwall sheet with no bottom diffuser attained a hiding power of about 0, and a luminance of greater than 130% (Sample 5). Unlike single sheet film (e.g., PC 1311-60), the multiwall sheet has diminished properties when combined with a diffuser. However, as can be seen, the multiwall sheet can be used to attain a luminance greater than or equal to that of PC 1311-60, or, more specifically, about 100% to about 130%, or, even more specifically, about 105% to about 120% of the luminance of PC 1311-60.

The ability to hide a light and dark light pattern(s) created by an array of CCFL's (hiding power) is important in applications such as LCD TVs, and the like). This can be accomplished with light diffusion, so that one cannot see the image of the CCFL's through the diffuser sheet. Hence, it is desirable that as much light as possible pass through the diffuser sheet (i.e. diffuser sheet should have high luminance (brightness)). Balance of these properties, hiding power and luminance, provides superior performance. A diffuser film comprising light diffusing particles having a refractive index (RI) of about 1.50 to about 1.55 (e.g., crosslinked PMMA-PS particles) and a particle diameter of about 2 μm to about 5 μm, enables such a balance, providing unexpectedly enhanced luminance while retaining hiding power.

The backlit device can use a multiwall sheet that has an increased stiffness ratio, a decreased weight, and a decreased yellowness, as compared to a polycarbonate sheet (i.e., PC 1311-60). For example, the stiffness ratio can be greater than or equal to about 1.1, or, more specifically, greater than or equal to about 1.3, or, even more specifically, greater than or equal to about 1.5, and even more specifically, greater than or equal to about 1. The stiffness is ratio of area moment inertia about the z axis as determined by the following formula:

$${I}_{z} = {\int }_{A} {y}^{2} d A$$

where:

I_{z} is the area moment of inertia about the z axis;

y is distance from the z axis; and

A is area; and

wherein the z axis is the neutral axis of the cross section and it passes through the centroid of the cross-section, with the y axis being perpendicular to the walls, the z axis being parallel to the plane of the walls, and the x axis is parallel to the plane of the ribs.

The weight of the multiwall sheet can be less than or equal to about 1.7 kg/m², or, more specifically, less than or equal to about 1.4 kg/m², or, even more specifically, less than or equal to about 1.0 kg/m².

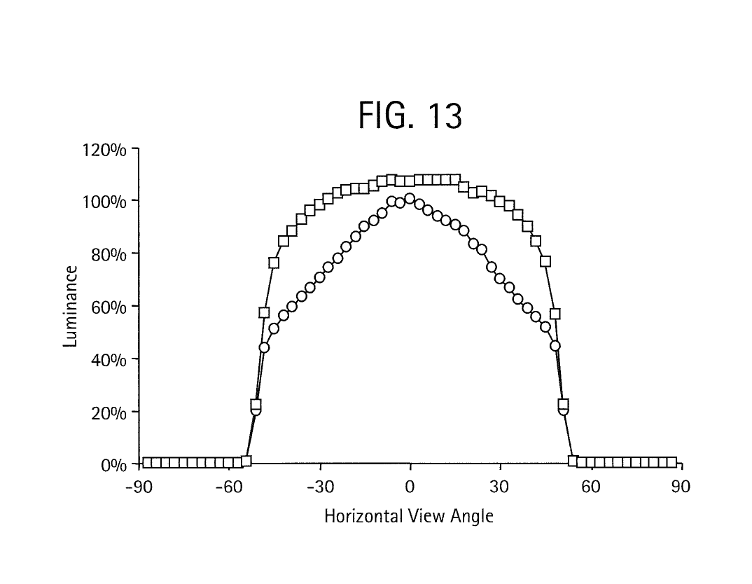

FIG. 13 illustrates the improvement in luminance for a multiwall sheet stack (multiwall sheet with a collimating film illustrated as the line with squares) versus a solid sheet stack (solid sheet with bottom diffuser and a collimating film is illustrated as the line with the circles). As can be seen from the graph, substantially more light is directed toward the display and therefore the luminance is significantly improved. Increased luminance was due to the lower absorption of the multiwall sheet that has thinner walls than the solid sheet.

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and can or can not be present in other embodiments. In addition, it is to be understood that the described elements can be combined in any suitable manner in the various embodiments. As used herein, the terms sheet, film, plate, and layer, are used interchangeably, and are not intended to denote size.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the invention has been described with reference to several embodiments thereof, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1. A backlit device, comprising:
a multiwall sheet having a viewing side, wherein the multiwall sheet comprises;
polymer walls; and
a rib that intersects at least two of the walls, wherein the rib comprises a non-linear geometry; and
a light source located on a side of the multiwall sheet opposite the viewing side, wherein the light source is configured to direct light at the multiwall sheet.

2. The device of claim 1, wherein an outer wall of the multiwall sheet comprises indentations, and wherein the light source is disposed adjacent to the indentations.

3. The device of claim 1, comprising a hiding power of 0 to about 2.

4. The device of claim 1, wherein rib comprises a different composition than at least one of the walls.

5. The device of claim 1, wherein the rib has a different thickness than the walls.

6. The device of claim 5, wherein the rib thickness is about 25% to about 80% of a wall thickness.

7. The device of claim 1, wherein the rib is textured.

8. The device of claim 1, comprising no diffusing sheet between the multiwall sheet and the light source.

9. The device of claim 1, wherein the multiwall sheet has a weight of less than or equal to 2 kg/m².

10. The device of claim 1, further comprising a collimating sheet located on the viewing side of the multiwall sheet.

11. The device of claim 10, further comprising a liquid crystal display, wherein the collimating sheet is located between the viewing side of the multiwall sheet and the liquid crystal display.

12. The device of claim 1, wherein the rib has a ratio of amplitude to period of about 0.6 to about 5.4.

13. The device of claim 1, further comprising further comprising a recycling polarizer sheet, wherein the recycling polarizer sheet is located between the viewing side of the multiwall sheet and the liquid crystal display.

14. A backlit device, comprising:
a multiwall sheet having a viewing side, wherein the multiwall sheet comprises;
walls, wherein an outer wall on the viewing side has a wall transmission; and
a rib that intersects at least two of the walls, wherein the rib has a rib transmission that is greater than the wall transmission as determined in accordance with ASTM D1003-00; and
a light source located on a side of the multiwall sheet opposite the viewing side, wherein the light source is configured to direct light at the multiwall sheet.

15. A backlit device, comprising:
a multiwall sheet having a viewing side, wherein the multiwall sheet comprises;
polymer walls; and
a rib that intersects at least two of the walls, wherein the rib comprises a textured surface; and
a light source located on a side of the multiwall sheet opposite the viewing side, wherein the light source is configured to direct light at the multiwall sheet.

16. The device of claim 15, wherein the textured surface is on the viewing side.

17. A backlit device, comprising:
a multiwall sheet having a viewing side, wherein the multiwall sheet comprises;
polymer walls; and
a rib that intersects at least two of the walls, wherein the rib comprises a sinusoidal geometry;
a light source located on a side of the multiwall sheet opposite the viewing side, wherein the light source is configured to direct light at the multiwall sheet;
an liquid crystal display located on the viewing side of the multiwall sheet; and
a collimating sheet located between the liquid crystal display and the multiwall sheet.

18. The device of claim 17, further comprising a diffuser sheet located between the multiwall sheet and the collimating sheet.

19. A backlit device, comprising:
a multiwall sheet having a viewing side, wherein the multiwall sheet comprises;
polymer walls; and
a rib that intersects at least two of the walls;
wherein the multiwall sheet has a weight of less than or equal to 1.9 kg/m²;
a light source located on a side of the multiwall sheet opposite the viewing side, wherein the light source is configured to direct light at the multiwall sheet; and
a collimating sheet located on the viewing side of the multiwall sheet;
wherein the device has a hiding power of 0 to about 2.0.

20. A method for making a backlit device, comprising:
locating a multiwall sheet between a light source and a collimating sheet, wherein the multiwall sheet comprises polymer walls and a rib that intersects at least two of the walls.

21. The method of claim 20, further comprising coextruding the multiwall sheet and a diffuser sheet.

22. The method of claim 20, further comprising disposing a liquid crystal display on a side of the collimating sheet opposite the multiwall sheet.
